(19) United States
(12) Patent Application Publication
(10) Pub. No.: US 2011/0034572 A1
(43) Pub. Date: Feb. 10, 2011

(54) VOLUME TILE ADHESIVE

(75) Inventor: Paul Mueller, Koningsbrunn (DE)

Correspondence Address: FULBRIGHT & JAWORSKI, LLP, 666 FIFTH AVE, NEW YORK, NY, 10103-3198, US

(73) Assignee: CONSTRUCTION RESEARCH & TECHNOLOGY GMBH, Trostberg (DE)

(21) Appl. No.: 12/936,927

(22) PCT Filed: Mar. 16, 2009
(86) PCT No.: PCT/EP2009/053048

§ 371 Date: Oct. 29, 2010

(30) Foreign Application Priority Data
Apr. 15, 2008 (DE) 10 2008 018 802.6

(51) Int. Cl. C08J 9/06

(52) U.S. Cl. 521/68

(57) ABSTRACT

The use of a mixture consisting of a) alkaline hydraulic binder, b) cellulose ether, c) blowing agent, d) filler as a tile adhesive is claimed, wherein the blowing agent c) comprises peroxo compounds and/or percarbonates and/or aluminum powder and wherein the tile adhesive mixture has a maximum and stable volume increase of 50% by volume within five minutes after admixing of water. This mixture, which may also comprise further additives such as, for example, retardants, antifoams and polymer dispersion powders, in addition to said four components, has the advantage that the blowing agent used reacts virtually completely within 5 min and thus leads to a volume increase of the tile adhesive mixture of not more than 50% by volume. After it has hardened, the mixture has a high intrinsic strength but also sufficient bonding strength and adhesive strengths with respect to the tile/substrate system.

The present invention relates to the use of a defined mixture as a tile adhesive and to a process for the preparation of a tile adhesive.

Tile adhesives comprising hydraulic binders and in particular comprising cement are sufficiently known from the prior art. In this context, reference may be made, for example, to DE 2006/256 U1, DE 199 57 101 A1, DE 197 46 201 A1, DE 195 49 441 A1, DE 103 15 865 B3 and DE 101 07 614 A1.

In said documents, different approaches to solving the very wide range of problems in relation to tile laying are described.

The use of light fillers in tile adhesive formulations has also recently become established (e.g. DE 10 2004 030 921 A1). The use of light fillers in such systems improves the processing properties of the mortars formulated therewith. The adhesive mixed with water has an airy lightness and is thus easier to apply with a notched trowel to the substrate.

Owing to the lower bulk density of the dry mortar mixes and the lower density of the mortar mixed with water, a greater productivity of the dry mortars, based on the laid area, is achieved. This means that a larger area of laid tile covering can be achieved with the same amount by weight of dry mortar.

Light fillers used in these tile adhesives are in particular fillers having a low density of >1 g/cm³ and a maximum particle size of 1 mm (e.g. pumice, expanded glass, expanded mica, etc.). Such light fillers are, however, available only in a quantitatively limited amount on the market and are relatively expensive in comparison with conventional fillers, such as, for example, quartz sand. Thus, the adhesives formulated with light fillers are likewise expensive in their material price.

DE 10 2004 030 921 A1 already cited describes a mineral adhesive having high productivity, this high productivity being achieved mainly by the use of a blowing agent. By means of the blowing agent, the volume of the adhesive mixed with water is increased by at least 50% by volume within a certain maturing time. The preferred use of the adhesive thus obtained is for the production of masonry from masonry units. In this case, a large volume increase of more than 50% by volume is desired. The volume increase of the adhesive which still takes place after the adhesive bonding of the masonry bricks is also advantageous since additional cavity filling or joint filling of the masonry adhesively bonded therewith is achieved thereby.

However, such an adhesive is not suitable for the laying of tile materials. Owing to the large volume increase of more than 50% by volume, the tile adhesive stability required for laying tile materials on walls is in fact not achieved. Tiles thus laid would subsequently slip off. Moreover, it should be noted that, after they harden, tile adhesives must have high intrinsic strengths in order to achieve the required bonding strengths and adhesive strengths regarding the tile/substrate system. However, this is not possible in the case of the high gas and volume fractions and the associated low intrinsic strengths of the mortars prepared and hardened according to DE 10 2004 030 921.

Furthermore, a maturing time of not more than 5 minutes is required for tile adhesives according to the prior art to date. An adhesive volume increase which continues after this time as is the case, for example with brick adhesives according to

DE 10 2004 030 921 and is entirely desirable, would, on use as a tile adhesive, lead to slipping of the tile covering already laid in the adhesive bed and hence to an inadequate joint pattern.

It was an object of the present invention to provide a tile adhesive which has all advantages of the use of light fillers but can be more economically formulated.

This object was achieved by the use of a mixture consisting of
a) alkaline hydraulic binder,
b) cellulose ether,
c) blowing agent,
d) filler
   as tile adhesive. In the tile adhesive used according to the invention, blowing agent c) comprises peroxo compounds and/or percarbonates and/or aluminum powder and the tile adhesive mixture has a maximum and stable volume increase of 50% by volume within five minutes after admixing water.

What is essential here to the invention is in particular that the blowing agents employed are used in an amount which lead to a volume increase of the tile adhesive mixture within 5 minutes of not more than 50% by volume, the respective blowing agents reacting rapidly and virtually completely in this time span.

It has been found that, with the mixture used according to the invention, it is possible to provide a tile adhesive which not only has the known advantages of the tile adhesives comprising light fillers but which can be formulated substantially more economically. This is surprising in that, starting from the prior art, it could not be assumed that the volume increase in adhesive according to the invention has taken place after a maturing time of only 5 min to such an extent that the laying of tile materials is possible. Furthermore, it was surprising that the tile adhesive prepared with this mixture and hardened has the required intrinsic strengths.

The present invention envisages cement and preferably a Portland cement, high-alumina cement, oil shale cement or mixtures thereof as preferred component a).

Cellulose ethers are a further substantial constituent of the mixture used. In principle, all representatives as disclosed in the prior art in relation to the use in tile adhesives are suitable as preferred representatives of this component b). However, methylcellulose, methylethylcellulose ether, methylhydroxypropylcellulose ether and of course all suitable mixtures thereof are particularly suitable.

As preferred filler component c), the present invention considers those based on quartz, limestone, and barite but also light fillers and once again all suitable mixtures thereof.

Regarding the respective individual amounts of the components a), b), c) and d), the present invention is not subject to any limitation at all. However, it has proven advantageous if the mixture used according to the invention comprises the component a) in an amount of from 10 to 80% by weight and preferably from 30 to 70% by weight, based in each case on the total dry mass of the mixture. The component b) should be present in the mixture in amounts of from 0.1 to 15% by weight, in particular from 0.1 to 10% by weight, preferably from 0.1 to 5% by weight and particularly preferably from 0.1 to 1% by weight. The amounts mentioned in each case once again relate to the total dry mass of the mixture used according to the invention.

For the component d), the fillers, amounts of from 5 to 80% by weight, in particular from 25 to 70% by weight and particularly preferably from 40 to 60% by weight are suitable. Said light fillers should be present in an amount of from 5 to 30% by weight, based on the total dry mass.

A substantial aspect of the present invention, as already indicated, is associated with the blowing agent component c). In this context, the invention takes into account a variant in which the mixture comprises peroxocarbonates, peroxomonocarbonates, peroxodicarbonates, sodium percarbonates, peroxoborates, sodium peroxoborate or mixtures thereof as the blowing agents. Where aluminum powder is used as the blowing agent, this should be present in very finely divided form and preferably in a particle size of ≦0.06 mm and in particular ≦0.01 mm. Altogether, it has been found to be advantageous with regard to the blowing agents used if they is present in an amount of from 0.1 to 30% by weight and preferably from 0.5 to 3.0% by weight, based in each case on the total dry mass.

In addition to said four obligatorily present components, the mixture used according to the invention may additionally comprise at least one additive which is selected in particular from the series consisting of the stability improvers, the retardants, the accelerators, the antifoams, the air-entraining agents and the polymer dispersion powders. The stability improver may be starch ether and/or a polyacrylamide and/or cellulose fiber and/or phyllosilicate, in each case in a preferred proportion of 0.1% by weight, based on the total dry mass. Suitable retardants are very generally inorganic mortar retardants which are preferably selected from the series consisting of the alkali metal pyrophosphates, the complex phosphates, the boron salts or sulfates. However, organic retardants are also suitable and here preferably those which are selected from the series consisting of the polyhydroxy compounds, such as, in particular, polyhydroxycarboxylic acids, sugar-containing ligninsulfonates, polysaccharides, such as saccharoses, glucoses and fructoses, and malic acid, gallic acid, gluconic acid, tartaric acid and citric acid. Of course, their salts, derivatives and suitable mixtures are also suitable. The retardants chosen in each case or the corresponding mixture should be present in proportions of from 0.01 to 10% by weight and particularly preferably in proportions of from 0.1 to 5% by weight, based in each case on the total dry mass.

Mortar accelerators, such as lithium carbonate, calcium carbonate, calcium nitrate, calcium formate and mixtures thereof, are typical representatives of accelerators as can be used in the present case of the invention. Proportions of from 0.1 to 5% by weight, based on the total dry mass, have been found to be very advantageous.

Regarding the component c), i.e. the blowing agent, reference has already been made to the peroxo compounds, percarbonates and aluminum powder essential to the invention. These should be used as solid, pulverulent substances, whereupon they undergo a chemical reaction with the mixing water, which has an alkaline pH owing to the hydraulic binders, with rapid liberation of gases. The compounds mentioned as being essential to the invention can in principle also be combined with other blowing agents which can liberate nitrogen, oxygen, hydrogen, carbon dioxide, carbon monoxide, ammonia or methane under the conditions of a mortar system mixed with water. In principle, a multiplicity of chemical substances is suitable in this context as a further suitable blowing agent. Of course, representatives of the hydrazines, of the hydrazides, of the azides, azo compounds, azodicarbonamides, toluenesulfonyl hydrazides, benzenesulfonyl hydrazides, toluenesulfonylacetone hydrazones, toluenesulfonyl semicarbazides, phenyltetrazoles and dinitrosopentamethylenetetramines may be mentioned as being typical. Sodium borohydrite is particularly suitable as a hydrogen-eliminating compound.

Suitable oxygen-eliminating compounds are organic peroxides and inorganic peroxides and suitable carbon dioxide-eliminating compounds are sodium dicarbonates and other alkali metal or alkaline earth metal carbonates.

Particularly suitable representatives of the peroxo and percarbonate compounds mentioned as being essential to the invention are sodium peroxoborate and sodium percarbonates, as also used, for example, in detergents for producing active oxygen.

In addition to the use, the present invention also claims a process for the preparation of a tile adhesive having a maximum and stable volume increase of 50% by volume, which is achieved within 5 min and after admixing water. In this process, a base mixture consisting of an alkaline hydraulic binder a), preferably a cement, a cellulose ether b), a blowing agent c), and a filler d) is stirred with mixing water, the blowing agent c) being selected from the series consisting of the peroxo compounds and/or percarbonates and/or finely divided aluminum powder, and this blowing agent or the corresponding blowing agent mixture being used in an amount of from 0.1 to 30% by weight, based on the total dry mass. Of course, in this case of the preparation process, the blowing agent component c) can also be combined with all other blowing agents which have already been described.

The following examples illustrate the advantages of the use according to the invention.

### EXAMPLES

The following standard mortar formulation was used for the working examples below:

| | |
|---|---|
| Quartz sand | 56.5% by weight |
| PZ 52.5 R (cement) | 18.5% by weight |
| Fly ash | 18.5% by weight |
| Vinnapas 546 Z (dispersion powder) | 3.65% by weight |
| Calcium formate (cement accelerator) | 1.8% by weight |
| Cellulose fibers | 0.6% by weight |
| Cellulose ether | 0.45% by weight |

1 kg of the respective dry mortar mixture was mixed with water to give a pasty mortar. After 5, 10 and 30 min, the volume increases of the blowing agent-containing mixtures (invention) were determined in comparison with standard mortar without blowing agent (zero % by volume increase).

### Example 1 (invention)

Standard mortar+1.0% by weight of sodium percarbonate

| | |
|---|---|
| Volume increase after 5 min | 14% by volume |
| Volume increase after 10 min | 16% by volume |
| Volume increase after 30 min | 16% by volume |

### Example 2 (invention)

Standard mortar+1.5% by weight of sodium percarbonate

| | |
|---|---|
| Volume increase after 5 min | 20% by volume |
| Volume increase after 10 min | 23% by volume |
| Volume increase after 30 min | 25% by volume |

The respective mortars (invention, comparison) were applied to a concrete slab with the aid of a notched trowel (6 mm serration) 20 minutes after stirring with water and earthenware tiles (5×5 cm) were laid immediately or 10 min or 20 min after application of the adhesive bed.

After 7 days, the adhesive strength values (ASV) were tested on the basis of DIN EN 12004 at room temperature:

| | | | Adhesive |
|---|---|---|---|
| | | | strength |
| | Tiles laid after | Fracture pattern | values |
| Example 1 | “immediately” | Fracture pattern: 100% loss of | 0.7 N/mm² |
| | | cohesion in the adhesive | |
| | 10 min | Fracture pattern: 80% loss of | 0.7 N/mm² |
| | | cohesion in the adhesive- | |
| | | 20% loss of adhesion between | |
| | | surface of tile and adhesive | |
| | 20 min | Fracture pattern: 80% loss of | 0.7 N/mm² |
| | | cohesion in the adhesive- | |
| | | 20% loss of adhesion between | |
| | | surface of the tile and | |
| | | adhesive | |
| Example 2 | “immediately” | Fracture pattern: 100% loss of | 0.6 N/mm² |
| | | cohesion in the adhesive | |
| | 10 min | Fracture pattern: 100% loss of | 0.5 N/mm² |
| | | cohesion in the adhesive | |
| | 20 min | Fracture pattern: 100% loss of | 0.5 N/mm² |
| | | cohesion in the adhesive | |

“Loss of cohesion” is understood as meaning an undesired material fracture within an adhesive (tile adhesive) as occurs, for example, in the case of excessive loading. “Loss of adhesion” is understood as meaning the undesired detachment of an adhesive (tile adhesive) from a surface (joint flank, tile surface) as occurs, for example, in the case of poor substrates or inadequate pretreatment of the substrate.

1-17. (canceled)

18. A process for the preparation of a tile adhesive having a maximum and stable volume increase of 50% by volume, which is achieved within five minutes after admixing with water, comprising:
stirring a base mixture consisting of an alkaline hydraulic binder a), a cellulose ether b), a blowing agent c) and a filler d) with water;
wherein the blowing agent c) is at least one member selected from the group consisting of a peroxo compound, a percarbonate and aluminum powder, and
wherein the blowing agent is present in an amount of from 0.1 to 30% by weight, based on the total dry mass of the base mixture.

19. A method comprising applying an adhesive to a tile, wherein the adhesive comprises:
a) an alkaline hydraulic binder,
b) a cellulose ether,
c) a blowing agent,
d) a filler; and
water;
wherein the blowing agent c) comprises at least one member selected from the group consisting of a peroxo compound, a percarbonate and aluminum powder, and
wherein the tile adhesive has a maximum and stable volume increase of 50% by volume within five minutes after preparing the tile adhesive by admixing the alkaline hydraulic binder, the cellulose ether, the blowing agent and the filler to form a base mixture, and admixing the base mixture with the water.

20. The method according to claim 19, wherein component a) is cement and preferably Portland cement, high-alumina cement, oil shale cement or mixtures thereof.

21. The method according to claim 19, wherein the component b) is at least one member selected from the group consisting of methylcellulose, methylethylcellulose ether and methylhydroxypropylcellulose ether.

22. The method according to claim 19 wherein the filler comprises at least one member selected from the group consisting of quartz, limestone, barite and a light filler.

23. The method according to claim 19, wherein the mixture comprises component a) in an amount of from 10 to 80% by weight, based on the total dry mass.

24. The method according to claim 19, wherein the mixture comprises the component b) in an amount of from 0.1 to 15% by weight, based on the total dry mass.

25. The method according to claim 19, wherein the mixture comprises the component d) in an amount of from 5 to 80% by weight, based on the total dry mass.

26. The method according to claim 19, wherein the mixture comprises the light fillers in an amount of from 5 to 30% by weight, based on the total dry mass.

27. The method according to claim 19, wherein the blowing agent comprises at least one member selected from the group consisting of a peroxocarbonate, a peroxomonocarbonate, a peroxodicarbonate, a sodium percarbonate, a peroxoborate and a sodium peroxoborate.

28. The method according to claim 19, wherein the aluminum powder is present in a particle size of ≦0.06 mm.

29. The method according to claim 19, wherein the mixture comprises the blowing agent in an amount of from 0.1 to 30% by weight, based on the total dry mass.

30. The method according to claim 19, wherein the mixture further additionally comprises at least one additive selected from the group consisting of a stability improver, a retardant, an accelerator, an antifoam, an air-entraining agent and a polymer dispersion powder.

31. The method according to claim 30, wherein the stability improver comprises at least selected from the group consisting of a starch ether, a polyacrylamide, a cellulose fiber and phyllosilicate.

32. The method according to claim 30, wherein the stability improver is present in an amount of from 0.1 to 10% by weight, based on the total dry mass.

33. The method according to claim 30, wherein the retardant is organic or inorganic.

34. The method according to claim 30, wherein the retardant is selected from the group consisting of an alkali metal pyrophosphate, a complex phosphate, a boron salt, a sulfate, a polyhydroxy compound, a polyhydroxycarboxylic acid, a sugar-containing ligninsulfonate, a polysaccharide, a saccharose, a glucose, a fructose, malic acid, gallic acid, gluconic acid, tartaric acid and citric acid, and their salts and derivatives and mixtures thereof.

35. The method according to claim 30, wherein the retardant is present in an amount of from 0.01 to 10% by weight based on the total dry mass.

36. The method according to claim 30, wherein the accelerator is a mortar accelerator comprising at least one member selected from the group consisting of lithium carbonate, calcium carbonate, calcium nitrate and calcium fat mate.
